(19) United States
(12) Patent Application Publication
(10) Pub. No.: US 2024/0005302 A1
(43) Pub. Date: Jan. 4, 2024

(54) CRYPTOCURRENCY COLD WALLET STORAGE DEVICE DISPENSER

(71) Applicant: NCR Corporation, Atlanta, GA (US)

(72) Inventors: Max Wiewiorka, Dundee (GB); Fraser Ford, Crieff (GB); Adam Loch, West Calder, West Lothian (GB)

(21) Appl. No.: 17/854,726

(22) Filed: Jun. 30, 2022

(51) Int. Cl. G06Q 20/36; G06Q 20/40

(52) U.S. Cl. CPC G06Q 20/363; G06Q 20/401; G06Q 2220/00

(57) ABSTRACT

A terminal and associated method is provided for dispensing a non-volatile memory storage device for storing user private information to a user. A device dispenser securely stores private information on a removable non-volatile memory storage device and then dispenses the removable non-volatile memory storage device to the user. A processor provides a user interface to the user, provides the user with access to a source of user private information via the user interface, receives the user private information from the source, and transfers the received user private information to the device dispenser for storage on the removable non-volatile memory storage device. The source may be a remote website for a cryptocurrency exchange. The user private information may be information, such as public and private keys, representing cryptocurrency ownership. The non-volatile memory storage device may be a cold wallet storage device.

### FIELD

This disclosure relates to a cryptocurrency cold wallet storage device dispenser.

### BACKGROUND

A cryptocurrency is a digital currency designed to work as a medium of exchange through a computer network that is not reliant on any central authority, such as a government or bank, to uphold or maintain it. Individual ownership records are stored in a digital ledger, typically in a distributed and decentralized form. A cryptocurrency is thus a tradable digital asset or digital form of money, built on blockchain technology that only exists in digital form online. Cryptocurrencies use encryption to authenticate and protect transactions, hence their name. The distributed ledger is a computerized database using strong cryptography to secure transaction records, to control the creation of additional cryptocurrency (coins), and to verify the transfer of ownership. The distributed ledger may be in the form of a blockchain, i.e., a publicly distributed ledger managed by a peer-to-peer network. A blockchain is comprised of a growing list of records contained in linked blocks and secured by cryptographic techniques. Each block of a blockchain may contain transaction information, account information, information about one or more previous blocks, and other related information. A blockchain is typically implemented in a peer-to-peer network comprising a plurality of blockchain nodes adhering to a protocol for inter-node communication, transaction or block validation, and consensus formation. A blockchain thus provides a way to create and maintain permanent records and to make the records accessible to a plurality of parties. Blockchain nodes collectively adhere to a protocol to communicate and validate new blocks.

The popularity and usage of cryptocurrencies has grown exponentially in recent years, and the concern for the security thereof has grown a great deal as well. Cryptocurrency, by its digital nature, is susceptible to cybercrime, especially when owned by new or inexperienced users. Most such users store their cryptocurrency ownership records (e.g., a bitcoin wallet that stores access codes) on cryptocurrency exchanges such as Coinbase, Kraken, or Gemini. Such exchanges are convenient, but have a high risk of loss due to scams, theft, and fraud. Over $1.65 billion in cryptocurrency has been stolen from cryptocurrency exchanges in the last ten years. Due to the digital nature of the cryptocurrency ownership records, there is very often little to no recourse for recovering loss once such records are compromised. As a result, many users have begun to use a hardware wallet, i.e., a secure digital device, to store the private keys that correspond to their cryptocurrency ownership records. A hardware wallet, also called a cold wallet, is one type of digital wallet which is only connected to the internet to perform transactions and is disconnected otherwise. This is in contrast to a hot wallet, which may exist on either the client or server side and which is always connected to the internet. Cold wallets solutions presently available are expensive to use.

Accordingly, there is a need for a less-costly and more secure way to store cryptocurrency ownership records.

### BRIEF DESCRIPTION OF THE DRAWINGS

The following detailed description, given by way of example and not intended to limit the present disclosure solely thereto, will best be understood in conjunction with the accompanying drawings in which:

FIG. 1A is a block diagram of a terminal-based cold wallet storage dispenser according to the present disclosure, FIG. 1B is a block diagram of a processor for use in that terminal, and FIG. 1C is a block diagram of a cold wallet storage device according to the present disclosure;

FIG. 2 is a flowchart of one aspect of the operation of the terminal-based cold wallet storage dispenser according to the present disclosure; and

FIG. 3 is a flowchart of another aspect of the operation of the terminal-based cold wallet storage dispenser according to the present disclosure.

### DETAILED DESCRIPTION

In the present disclosure, like reference numbers refer to like elements throughout the drawings, which illustrate various exemplary embodiments of the present disclosure.

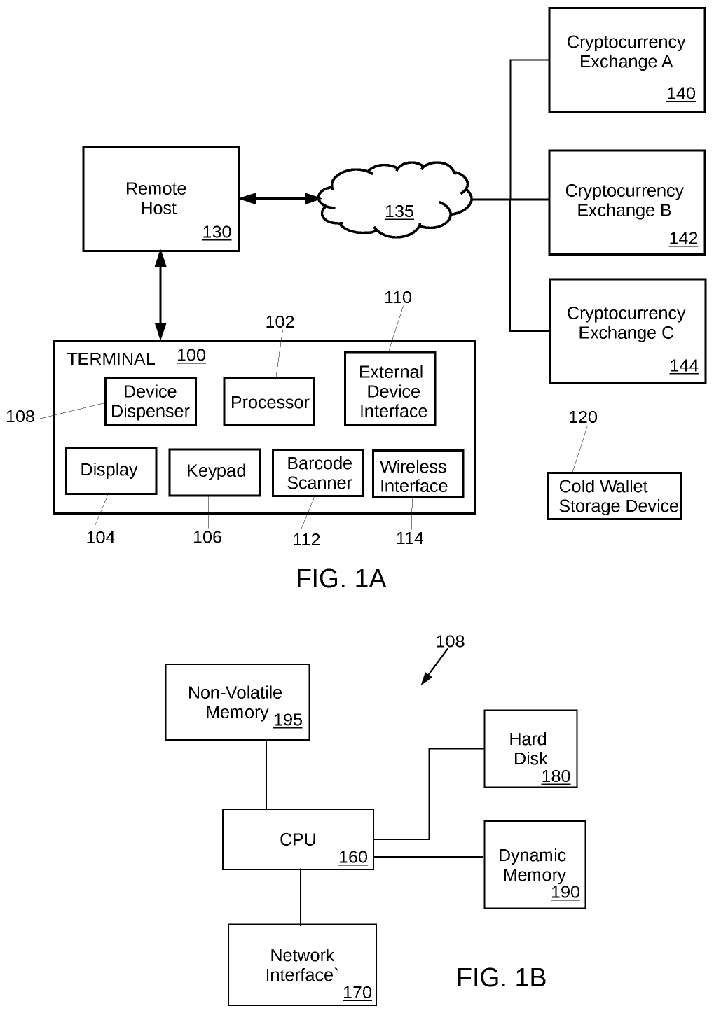

Referring now to FIG. 1A, a terminal 100 includes a processor 102 (described below), a display 104, and a keypad 106. Terminal 100 may be a self-service terminal used exclusively for dispensing or communicating with cold wallet storage devices or, in an alternative, be an automated teller machine (ATM) or other type of dual-use self-service terminal (SST). Processor 102 is coupled to display 104 and to keypad 106 to provide a user interface via the display 104 and the keypad 106 for operating terminal 100. In an embodiment, display 104 may be a touchscreen which incorporates features that allow some (or all) of the user operations to be performed without using keypad 106. Keypad 106 may be required, however, when terminal 100 is an ATM or the like, in order to provide a secure method of password entry. Terminal 100 also includes a device dispenser 108 for dispensing a cold wallet storage device 120 to the user and may include an external device interface 110 for communicating with a previously-dispensed cold wallet storage device 120. In some cases, the external device interface 110 may be part of device dispenser 108. In some cases, the external device interface 110 may be located behind a shutter in terminal 100 which only opens under control of processor 102 at an appropriate time after a user has logged into terminal 100. The cold wallet storage device 120 (shown in FIG. 1C) is a physical device used to store ownership information (e.g., public and private keys) for cryptocurrency offline and thus provide a much higher level of security than for cryptocurrency ownership information stored online. Device dispenser 108 contains a bin for holding blank cold wallet storage devices 120, a first mechanism for coupling a blank cold wallet storage device 120 from the bin to an appropriate connect for programming, and a second mechanism for making a programmed cold wallet storage device 120 available to the user after programming. The first mechanism may include, for example, a conveyor coupled to the bin to receive a blank cold wallet storage device 120 and a movable connector with pins that contact a connector on the blank cold wallet storage device 120 when positioned in proximity thereto. The second mechanism may be, for example, a shutter on the front of terminal 100 that opens after the cold wallet storage device 120 has been programmed. Programming the cold wallet storage device 120 refers to storing the private key thereon. Terminal 100 may also include a barcode scanner 112 and a wireless interface 114. The barcode scanner 112 may be used to read barcodes representing cryptocurrency ownership information that may be printed on paper or displayed on a mobile device screen. Wireless interface 114 is configured to establish a secure communication channel with a user mobile device during a transaction in order to receive information representing cryptocurrency ownership information from that user mobile device. Wireless interface 114 may communicate via one or more of a local Wi-Fi channel (IEEE 802.11), a Bluetooth wireless channel, or a near field communication (NFC) channel.

Terminal 100 is coupled to a remote host 130 via a network connection. The remote host 130 manages user account information, including password information. When terminal 100 is an ATM, remote host 130 is also manages bank account information for each user. When terminal 100 is an SST, remote host 130 is also manages the user account information for each user for the service provided by the SST. Remote host 130 also serves as an interface, via the internet 135, to remote cryptocurrency exchange websites, shown as cryptocurrency exchange A 140, cryptocurrency exchange B 142, and cryptocurrency exchange C 144 in FIG. 1A. These remote websites may correspond to, for example, Coinbase, Kraken, and Gemini.

As shown in FIG. 1B, the processor 102 includes one or more central processing units 160, a network interface 170 (for connection to remote host 130), at least one hard disk (HD) 180, volatile memory 190, and non-volatile memory 195. The non-volatile memory 195 includes a basic input/output system (BIOS) used to initiate a boot of the processor 102. The HD 180 may be any type of non-volatile memory device (i.e., a non-transitory computer-readable storage medium) used to hold an operating system for a computer-based system and the term “hard disk” as used herein is intended to be broadly defined to include both electro-mechanical data storage devices and solid state drives. The HD 180 holds the programs (software applications) which load into volatile memory 190 upon boot of the operating system to provide the functionality discussed herein. It is to be noted that the components are shown schematically in greatly simplified form, with only those components relevant to understanding of the embodiments being illustrated. The various components (that are identified in the FIG. 1B) are illustrated and the arrangement of the components is presented for purposes of illustration only. It is to be noted that other arrangements with more or less components are possible without departing from the teachings of the system and method presented herein. In one presently preferred embodiment, processor 102 comprises a computing system adapted to run a secure version of the Microsoft Windows® operating system.

Referring now to FIG. 1C, the cold wallet storage device 120 includes a connector 122, a controller 124, and non-volatile memory 126 and thus has an arrangement as a non-volatile memory storage device. The connector 122 may be a non-standard proprietary connector for use only with terminal 100 or may be an industry standard connector such as a universal serial bus (USB) connector or any of the other connector configurations used with non-volatile memory storage devices (this includes, for example, memory card connector layouts such as those used for CompactFlash Cards, SD Cards, etc.). The controller 124 is configured to receive signals representing a cryptocurrency ownership information from processor 102 for storage in non-volatile memory 126, either via an internal connector within device dispenser 108 or the external interface 110 that is connected to connector 122. In one embodiment, the signals received from processor 102 are encrypted using a private key of terminal 100. This private key may be shared among a family of terminals of a common owner so that the user can access their cryptocurrency key at any terminal among all the terminals in the family. The signals from processor 102 may include an identification code for the user (e.g., a user account number) that is also stored in non-volatile memory 126. In this case, the information in the cold wallet storage device 120 can only be accessed when the user having that identification code is logged into terminal 100. Terminal 100 will not allow an account holder to access cryptocurrency ownership information on a cold wallet storage device that is associated with another user account. In another embodiment, controller 124 has its own private key and/or requires entry of a separate user password in order to read from or write to non-volatile memory 126. In yet another embodiment, controller 124 is configured to read and write information in a proprietary format to non-volatile memory in order to secure the information stored therein.

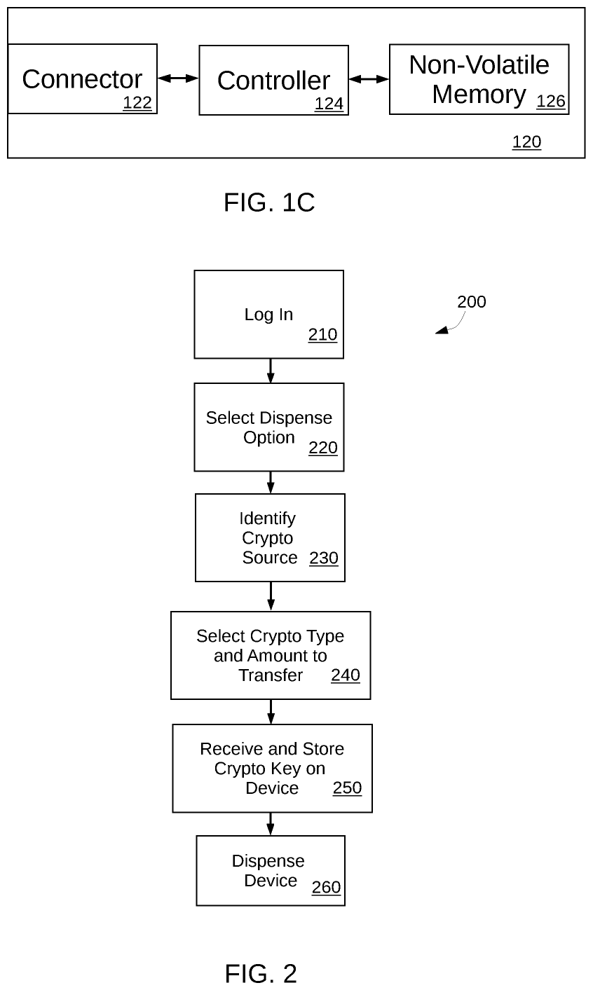

Referring now to the flowchart 200 in FIG. 2, a user transaction for obtaining a cold wallet storage device 120 first requires that a user log in to their account at the terminal 100 (step 210) via the user interface provided by processor 102 via display 104 and keypad 106. Terminal 100 may be dedicated to transfer or purchase of cryptocurrency or may be an ATM or other SST with functionality added to allow the transfer or purchase of cryptocurrency. Next, at step 220, the user selects an option, via the user interface, to transfer and dispense cryptocurrency (meaning the information representing ownership of the cryptocurrency) to a cold wallet storage device 120. At step 230, the user is prompted to choose a source for the cryptocurrency ownership information. For example, the user may choose one of a number of listed cryptocurrency exchanges and then log in to the chosen exchange. As alternatives, the user may choose a barcode option, a wireless option, or a keypad entry option. At step 240, the user selects a type and associated amount of cryptocurrency to transfer to the cold wallet storage device 120. The selected type and amount of cryptocurrency may be already owned by the user with ownership information stored at the selected exchange or may be part of a purchase made via the user's account at the selected exchange during the current transaction. The ownership information may be stored in barcode form on paper printouts or on a mobile device, or in digital form on a mobile device, or may even be stored in alphanumerical form on a paper printout. When the source is a cryptocurrency exchange and once the transfer (or purchase) is confirmed by the exchange, the ownership information (e.g., public and private key(s)) for the designated amount of cryptocurrency is transferred from the cryptocurrency exchange to the processor 102 in terminal 100. When the source is an external barcode, the user is prompted to present the barcode or barcodes (in whatever form, e.g., printed on paper or shown on a display) to the barcode scanner 112 to be read to obtain the cryptocurrency ownership information. When the source is an external mobile device and the user selects the wireless option, the wireless interface 114 establishes a secure connection with the wireless device to receive the cryptocurrency ownership information. When the sources is a paper printout showing the cryptocurrency ownership information in alphanumerical form, the user is prompted to enter the characters making up the cryptocurrency ownership information via keypad 106. At step 250, the processor 102 in terminal 100 receives the ownership information (e.g., public and private key(s)) and causes the device dispenser 108 to load the cryptocurrency ownership information onto a cold wallet storage device 120. The user may be prompted at this step to provide a new password only for use in later access of the cryptocurrency ownership information stored on the cold wallet storage device 120. Finally, at step 260, the programed cold wallet storage device 120 is dispensed for user to collect or obtain.

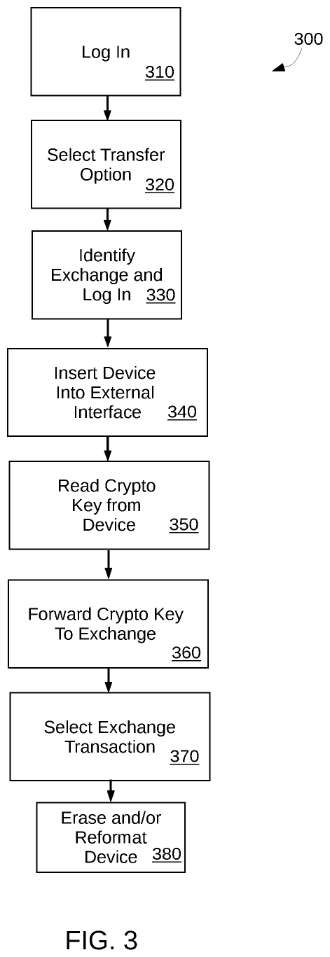

Referring now to the flowchart 300 in FIG. 3, a user transaction for trading cryptocurrency in which the ownership information therefor has been previously stored on a cold wallet storage device 120 is shown. A user first logs in to their account at the terminal 100 (step 310). Terminal 100 may be dedicated to transfer or purchase of cryptocurrency or may be an ATM or other SST with functionality added to allow the transfer or purchase of cryptocurrency. Next, the user selects the cryptocurrency transfer option at step 320. The user is provided with a list of available exchanges, and then selects a desired exchange and logs into their account at the selected exchange at step 330. The user then inserts a previously-obtained cold wallet storage device 120 into the external interface at step 340. The user may be prompted at this step to provide the previously designated password for this cold wallet storage device 120. Terminal 100 reads the cryptocurrency ownership information from cold wallet storage device at step 350, and forwards such information to the selected exchange at step 360. The user selects an appropriate transaction via the exchange web interface at step 370. For example, the transaction may be a sale of the cryptocurrency at the exchange or a transfer of the ownership information to be stored at the exchange. Thereafter, once the selected transaction is completed, terminal 100 may then erase and/or reformat the non-volatile memory in the cold wallet storage device 120 to ensure that no one can access any of the information previously stored thereon.

Although the present disclosure has been particularly shown and described with reference to the preferred embodiments and various aspects thereof, it will be appreciated by those of ordinary skill in the art that various changes and modifications may be made without departing from the spirit and scope of the disclosure. It is intended that the appended claims be interpreted as including the embodiments described herein, the alternatives mentioned above, and all equivalents thereto.

What is claimed is:

1. A terminal for dispensing a non-volatile memory storage device for storing user private information to a user, comprising:
a device dispenser for securely storing private information on a removable non-volatile memory storage device and then dispensing the removable non-volatile memory storage device to the user; and
a processor configured to:
provide a user interface to the user,
provide the user with access to a source of user private information via the user interface,
receive the user private information from the source, and
transfer the received user private information to the device dispenser for storage on the removable non-volatile memory storage device.

2. The terminal of claim 1, wherein the source is a remote website for a cryptocurrency exchange.

3. The terminal of claim 2, wherein the private information comprises a private key representing ownership of an amount of cryptocurrency.

4. The terminal of claim 1, wherein the private information is securely stored on the removable non-volatile storage device in an encrypted format.

5. The terminal of claim 4, wherein a key for the encrypted format is kept private in the terminal.

6. The terminal of claim 4, wherein a key for the encrypted format is kept private in a controller in the removable non-volatile storage device.

7. The terminal of claim 1, wherein the private information is securely stored on the removable non-volatile storage device in a proprietary format.

8. The terminal of claim 1, wherein the private information is securely stored on the removable non-volatile storage device in a password protected format.

9. The terminal of claim 1, wherein user identification information is securely stored with the private information that is securely stored on the removable non-volatile storage device.

10. A method of dispensing a non-volatile memory storage device for storing user private information to a user, comprising:
providing a user interface to the user via a display and keypad controlled by a processor;
providing the user with access to a source of user private information via the user interface;
receiving, at the processor, the user private information from the source;
transferring the received user private information to a device dispenser for storage on the removable non-volatile memory storage device;
securely storing private information on a removable non-volatile memory storage device at the device dispenser; and
dispensing the removable non-volatile memory storage device to the user.

11. The method of claim 10, wherein the source is a remote website for a cryptocurrency exchange.

12. The method of claim 11, wherein the private information comprises a private key representing ownership of an amount of cryptocurrency.

13. The method of claim 10, wherein the private information is securely stored on the removable non-volatile storage device in an encrypted format.

14. The method of claim 13, wherein a key for the encrypted format is kept private in the terminal.

15. The method of claim 13, wherein a key for the encrypted format is kept private in a controller in the removable non-volatile storage device.

16. The method of claim 10, wherein the private information is securely stored on the removable non-volatile storage device in a proprietary format.

17. The method of claim 10, wherein the private information is securely stored on the removable non-volatile storage device in a password protected format.

18. The method of claim 10, wherein user identification information is securely stored with the private information that is securely stored on the removable non-volatile storage device.

19. A terminal for accessing a cold wallet storage device, comprising:
an external device interface for coupling to the cold wallet storage device; and
a processor configured to:
provide a user interface to the user,
provide the user with access to a remote website via the user interface, the remote website for receiving user private information under user designation of a selected type transaction,
reading the user private information from the cold wallet storage device via the external device interface, and
transfer the user private information read from the cold wallet storage device to the remote website to complete the designated type of transaction.

20. The terminal of claim 19, wherein the remote website is a cryptocurrency exchange, the user private information is a private key representing an amount of cryptocurrency, and the designated type of transaction is a sale of the cryptocurrency.
